(19) United States
(12) Patent Application Publication
(10) Pub. No.: US 2005/0061600 A1
(43) Pub. Date: Mar. 24, 2005

(54) Automatic dual-function clutch

(76) Inventor: Ronald A. Holland, Orange, CA (US)

Correspondence Address: Robert G. Lancaster, Esq.;BRYAN CAVE LLP, One Metropolitan Square, 211 North Broadway, Suite 3600, St. Louis, MO, 63102, US

(21) Appl. No.: 10/668,068

(22) Filed: Sep. 22, 2003

(51) Int. Cl. B62K 11/00

(52) U.S. Cl. 192/48.92; 192/105 BA; 180/221

(57) ABSTRACT

An automatic dual-function clutch for use on an engine-assisted vehicle comprises a case hardened ground shaft through-bored to form a hollow shaft. The hollow shaft is counter-bored on each end to accept drawn cup needle bearings on each end. One end of the shaft is pressed into or otherwise fixedly mounted to the drum hub of the centrifugal clutch. A clutch bearing is preferably pressed into the shoe assembly hub of the centrifugal clutch and fitted over the hollow shaft. A “V” belt pulley is fixedly mounted to each side of the centrifugal clutch concentric with the hubs, and the entire assembly is rotatably mounted on a second case hardened shaft, which in turn is fixedly mounted to the engine through arms on each end of the shaft.

### FIELD OF INVENTION

1. The present invention relates in general to centrifugal clutches and more particularly to an automatic dual-function clutch for use on an internal combustion (IC) engine-assisted bicycle, for example, the type described in detail in U.S. Pat. No. 2,529,919 to Cunningham.

### BACKGROUND

2. The bicycle described in the Cunningham patent, with 24 to 26 inch diameter wheels and utilizing a single speed, “v” belt type drive has two stages of speed reduction between the engine and the drive wheel, primarily to limit it to a safe speed for a bicycle and to develop enough torque at the rear wheel to negotiate a moderate incline. The space available in the frame between the pedals is not wide enough to mount an automatic clutch on the end of the engine shaft, so the clutch is normally mounted on an intermediate shaft behind the engine and parallel to the engine shaft. The offset between the first and second stage pulleys allows the second stage belt to run close to the tire, so that the pulley, attached to the spokes of the rear wheel, will not interfere with the frame of the bicycle. About fifty years ago this was the most popular type of engine-assisted bicycle. There were many thousands of them sold at that time, some with automatic dual-function clutches, the functions of which are adequately described in the Cunningham patent.

3. In recent years there has been a resurgence of this type of engine-assisted bicycle and again there have been thousands of them sold with the rudimentary, belt-slipping type of manual clutches. It is much more convenient and pleasurable to ride these bicycles with automatic clutches installed, but all of the recent attempts to design and manufacture such a dual-function clutch have failed, mainly due to cost. Therefore there is a need for a low cost clutch that can meet these functional and space requirements.

4. Although the Cunningham patent describes the use and the need for the dual-function clutch, it teaches a technology that is overly complicated and leaves great doubt about its practicality and durability. This is probably the reason that there seems to be no evidence that such dual function clutch was ever actually produced.

5. In the past, some of these dual-function clutches have utilized a centrifugal clutch combined with a ratchet and pawl device, as in U.S. Pat. No. 3,393,781 to Miura. The ratchet device was placed between the input side (shoe assembly) and the output side (drum) of the clutch, so that when the rear wheel drives the drum in the forward direction, the ratchet catches and drives the shoe assembly, which in turn drives the motor forward for starting. When the motor starts, causing torque in the opposite direction, the ratchet automatically disengages and the shoe drive mechanism turns freely, except for the small amount of friction generated from the sliding ratchet.

6. The most popular types of the prior art clutches were built on the technology disclosed in U.S. Pat. No. 2,286,461 to Burns, which teaches a friction type pawl, built into the centrifugal clutch mechanism, which works against the drum of the clutch to perform the starting function. The pawl must be biased against the friction material on the inner surface of the drum to provide the correct clutching action. This surface is located at almost the largest diameter on the clutch, which causes significantly larger drag during the driving function than the ratchet on the Miura clutch described above.

7. U.S. Pat. No. 2,663,397 to Scott discloses a built in roller clutch working against each shoe for the engine starting function. Although the functionality seems quite acceptable, with very low drag, it is highly specialized. The clutch, being an integral part of the engine flywheel, seems quite functional, except that, on a bicycle with 24 to 26 inch diameter wheels, an intermediate shaft with double reduction pulleys must still be used to meet the torque requirements. Therefore, the required configuration is even more specialized, without simplifying the total drive train. The cost of manufacturing the clutch of the Cunningham, Miura, Bums, or Scott patent today, in the relatively limited quantities anticipated for this application, would be extreme and prohibitive. Any of the specialized components such as the ratchet, friction pawl, roller clutch, or their support structure within the clutches, would require new and expensive production tooling, because there is nothing that is presently mass-produced that will match the special shape and size requirements of these old components.

8. Recognizing the need for an automatic, dual-function clutch, the primary manufacturer of engine-assisted bicycles recently attempted to build what was expected to be an affordable, dual-function clutch using a mass-produced ratchet (free-wheel) from the bicycle industry. But even the smallest free-wheel available required the clutch and attached pulleys to be so large that they rotated too slowly, which caused the clutch to slip excessively and provided insufficient torque during initial acceleration and for hill climbing. After many clutches were already produced, it was discovered that their excessive weight, in combination with the vibration of the engine, caused failures of the clutch and its supporting structure. Because of their large size, lack of durability, and unsatisfactory performance, the clutches were all scrapped, and soaring costs forced the abandonment of the whole project.

9. Mass-produced, automatic clutches for small, IC engines (5 hp and under) are generally mounted to the engine shaft and centrifugally actuated. In the simplest, most functional, and lowest cost versions, the shoe drive mechanism is rigidly mounted to the engine shaft and the shoes are biased inward toward the center of rotation and away from the drum by a single spring as illustrated in U.S. Pat. No. 5,921,364 to Kobayashi. The drum with a pulley or sprocket rigidly attached is rotatably mounted over the shoes concentric to the motor shaft. When the motor reaches a predetermined speed, the centrifugal force on the shoes overcomes the spring resistance and the shoes contact the drum, driving the pulley with increasing speed and torque as the speed of the motor increases.

### SUMMARY OF THE INVENTION

10. By adding a support from the flywheel side of the engine of an engine-assisted bicycle to the outer end of the intermediate shaft, thereby supporting it on both ends, the shaft can be made smaller in diameter. This smaller diameter shaft provides the space to fit a small, commercially available needle clutch bearing assembly between the shoe assembly hub of a commercially available centrifugal clutch and the smaller intermediate shaft. This arrangement will produce the desired engine starting function, without having to build the starting device into the actual centrifugal clutch mechanism. The smaller clutch assembly allow the use of pulleys with smaller outer diameters, thus providing the required speed reduction while increasing the speed of the clutch and producing the desired torque.

11. It is the purpose of this invention to disclose a new, improved automatic clutch for both starting and driving an IC engine-assisted vehicle that can be made primarily from inexpensive, commercially available parts assembled in a new and unique manner.

12. It is also the purpose of this invention to disclose a method for retrofitting such improved clutches on recently manufactured Whizzer Motorbikes by replacing only the two drive belts and the existing, undesirable clutch mechanism.

13. The present invention provides an automatic, dual-function clutch that combines a small, inexpensive, commercially available, centrifugal clutch to accomplish the driving function, with an inexpensive, commercially available, drawn cup, needle clutch bearing to accomplish the starting function. The centrifugal clutch is of the type exemplified by model No. SS1234 manufactured by MAX-TORQUE, LTD. at 2180 Corporate Lane, IL 60563. The clutch bearing is of the type exemplified by part No. HFL 2026 distributed by INA USA Corp. at 308 Springhill Farm Road, Fort Mill, S.C. 29715. A piece of case hardened ground shaft is cut to length and through-bored to form a hollow shaft. Next, the hollow shaft is counter-bored on each end to accept drawn cup needle bearings on each end. Then one end of the shaft is pressed into or otherwise fixedly mounted to the drum hub of the centrifugal clutch. Next, the clutch bearing is preferably pressed into or otherwise fixedly mounted to the shoe assembly hub of the centrifugal clutch and fitted over the hollow, case hardened shaft. A “V” belt pulley is fixedly mounted to each side of the centrifugal clutch concentric with the hubs and the entire assembly is rotatably mounted on a case hardened shaft, which in turn is fixedly mounted to the engine through arms on each end of the shaft. As a result of this simple, unique assembly and the use of commercially available, mass-produced parts, this dual function clutch can be manufactured, even in relatively limited quantities, for much less cost than prior art clutches.

14. Other objects, features, benefits, and advantages of this invention will become apparent from the following description of the invention, when viewed in accordance with the attached drawings and appended claims.

### BRIEF DESCRIPTION OF THE DRAWINGS

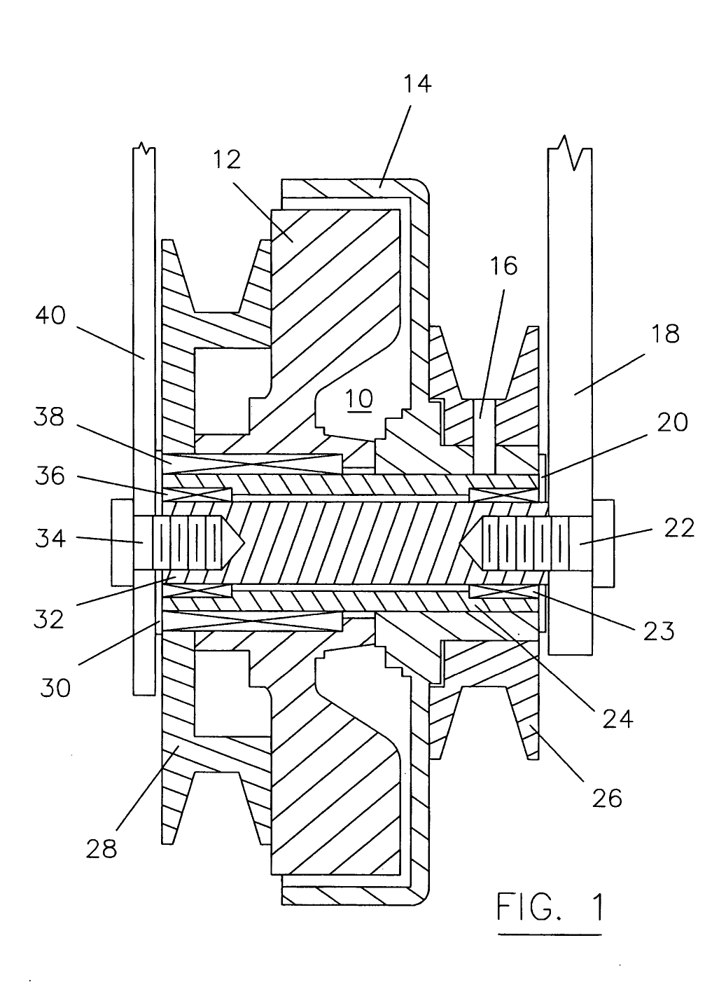

15. FIG. 1 is an illustrative, cross-sectional view of a dual-function clutch according to the present invention.

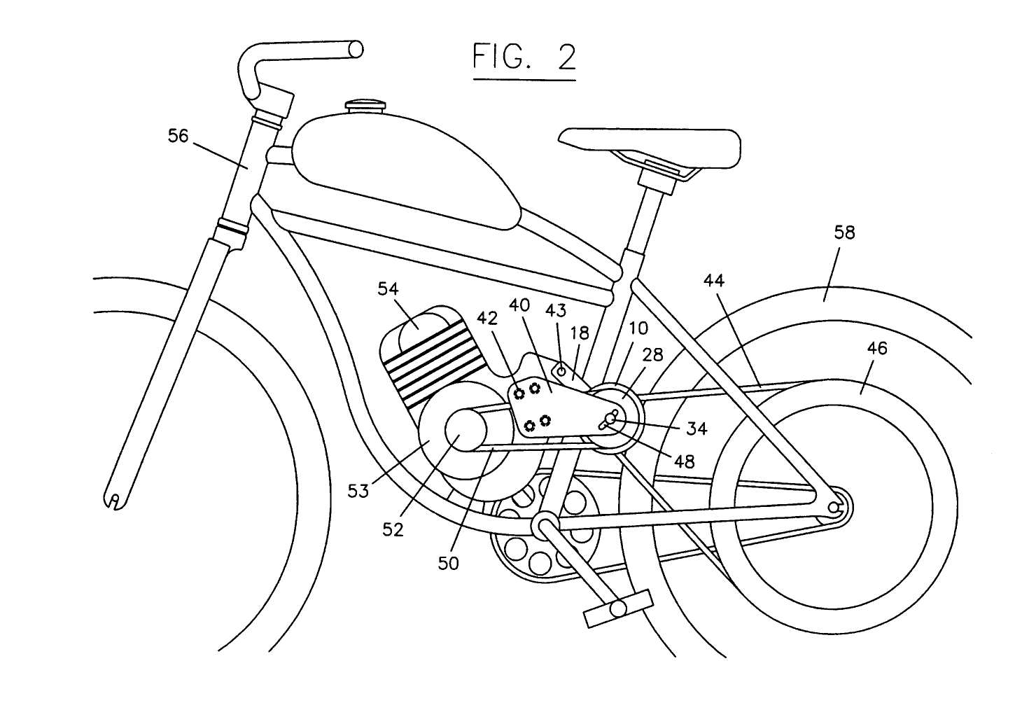

16. FIG. 2 is an illustration of a dual-function clutch according to the present invention installed on an exemplar IC engine-assisted bicycle.

### DETAILED DESCRIPTION OF THE PREFERRED EMBODIMENT

17. Referring to FIG. 1, for simplicity of illustration the mass-produced centrifugal clutch has been shown as only two assemblies; a cross sectional view of the shoe drive assembly 12 and a cross sectional view of the drum assembly 14. As is know in the art, the shoe drive assembly 12 of a mass-produced centrifugal clutch may include shoes, a shoe drive plate, a shoe retainer plate, a coiled-type shoe retaining spring, a snap-type retaining ring, and a hub. Also, as is know in the art, the drum assembly 14 of a mass-produced centrifugal clutch may include a drum and a hub, which may formed as an integral component.

18. The unidirectional needle clutch bearing 38 is pressed into the hub of the shoe assembly 12 and fitted onto one end of the hollow shaft 24. The other end of the hollow shaft 24 is pressed into the hub of the drum assembly 14. The two drawn cup needle bearings 23 and 36 are pressed into each end of the hollow shaft 24 and fitted over the stationary shaft 32. The small pulley 26 is fixedly attached to the hub of the drum assembly 14 by the roll pin 16. The large pulley 28 is welded to the outside drive plate of the shoe assembly 12.

19. The combined width of the clutch bearing 38, the shoe assembly 12, and the drum assembly 14 is about equal to the length of the hollow shaft 24. The stationary shaft 32 is about 15 to 30 thousandths of an inch longer than the combined length of the hollow shaft 24 and the hardened thrust washer 20. This arrangement provides clearance between the entire rotating assembly of the clutch 10 and the support arms 18 and 40 when they are firmly mounted to the stationary shaft 32 by the bolts 22 and 34. The clearance is necessary under the conditions when friction between the shoe assembly 12 and the drum assembly 14 generates enough heat in the rotating assembly of the clutch 10 to cause it to expand further than the cooler, stationary shaft 32. Hardened thrust washers 20 and 30 restrain the rotating pulleys 26 and 28 from contacting the support arms 18 and 40.

20. Referring to both FIGS. 1 and 2, left support arm 40 is mounted to four stanchions 42, which are individually connected to the case of engine 54 and extend outward beyond the pulley 52. These stanchions are a part of the production Whizzer engine to support the cover (not shown) for flywheel 53 and the original production model belt and pulley components which have been removed (not shown). Clutch 10 is located so that the original production model cover can still be used by rotating it down around the flywheel 53 and mounting it in new holes in the left support arm 40. The right support arm 18 is rotatably mounted to the case of engine 54 with a single bolt 43, so that belt 50 can be tensioned by sliding the bolt 34 upward in slot 48 and secured in position by tightening bolts 34 and 43. Belt 44 can be tensioned by moving the engine 54 forward on its mounts (not shown). Right support arm 18 is mounted in the same location as the original single support arm (not shown), but the clutch 10 is dropped to a lower position to avoid interference between the stanchions 42 and the new belt 50 and pulley 28 configuration.

21. Referring again to both FIGS. 1 and 2, the operation of the automatic dual-function clutch will next be described as follows:

22. To start the IC engine 54, the bicycle 56 can be pedaled in a forward direction, thus driving the pulley 46 (attached to the rear wheel 58) forward. This drives the belt 44 forward, turning the small pulley 26 (on the right side of the clutch 10) forward. The small pulley 26, being pinned to the hub of the drum assembly 14 by the roll pin 16, turns the drum assembly 14 forward. Since the hollow shaft 24 is pressed into the hub of the drum assembly 14 it is also driven forward. When being driven by the shaft 24 in the forward direction the clutch bearing 38 will lock and turn its outer race forward. The outer race of clutch bearing 38 is pressed into the hub of the shoe drive assembly 12 and will drive it forward also. Pulley 28 is then driven forward by shoe drive assembly 12 to which it is attached. This drives the belt 50 and the pulley 52, attached to the engine flywheel 53, in the forward direction, thereby starting the engine 54. When the engine 54 starts and the belt 50 drives the large pulley 28 forward faster than it is being driven by the bicycle 56, the clutch bearing 38 will unlock and rotate freely, allowing the engine 54 to idle when the bicycle 56 is moving slowly or stopped. When the engine 54 reaches a predetermined speed, the centrifugal clutch 10 will engage and drive the bicycle 56 up to the desired speed.

23. While the present invention has been illustrated by a description of the preferred embodiment and while this embodiment has been described in considerable detail in order to describe the best mode of practicing the invention, it is not the intention of the applicants to restrict or in any way limit the scope of the appended claims to such detail. Additional advantages and modifications within the spirit and scope of the invention will readily appear to those skilled in the art. The invention itself should only be defined by the appended claims.

1. A clutch for use on an engine-assisted vehicle comprising:
A centrifugal clutch comprising a shoe drive assembly having a hub with an inner surface, and a drum assembly having a hub with an inner surface;
A rotatable input drive member fixedly mounted to the shoe drive assembly;
A rotatable output driven member fixedly mounted to the drum assembly;
A unidirectional clutch bearing having an inner surface and an outer surface, the outer surface of the bearing fixedly mounted to the inner surface of the hub of the shoe drive assembly;
A shaft fixedly mounted to the inner surface of the hub of the drum assembly, and fitted against the inner surface of said clutch bearing to allow rotation of the shaft in one direction only; and
A means for rotatably mounting said shaft on the vehicle.

2. The clutch of claim 1, wherein said clutch bearing is a drawn-cup, needle clutch bearing.

3. The clutch of claim 1, wherein the shaft is hollow and has an inner surface, and wherein the means for rotatably mounting said shaft on the vehicle comprises a second shaft having an outer surface with a diameter less than the diameter of the inner surface of the hollow shaft and wherein the second shaft is fixedly mounted to the vehicle and wherein the hollow shaft is rotatably supported concentrically around the second shaft by needle bearings installed between and in contact with the outer surface of the second shaft and the inner surface of the hollow shaft.

4. The clutch of claim 3, wherein the second shaft has two ends and the second shaft is fixedly mounted to the vehicle by supports between each end to the case of said engine.

5. A clutch for use on an engine-assisted vehicle comprising:
A centrifugal clutch comprising a shoe drive assembly having a hub with an inner surface, and a drum assembly having a hub with an inner surface;
A rotatable input drive member fixedly mounted to the shoe drive assembly;
A rotatable output driven member fixedly mounted to the drum assembly;
A unidirectional clutch bearing having an inner surface and an outer surface, the outer surface of the bearing fixedly mounted to the inner surface of the hub of the drum assembly;
A shaft fixedly mounted to the inner surface of the hub of the drum assembly, and fitted against the inner surface of said clutch bearing to allow rotation of the shaft in one direction only; and
A means for rotatably mounting said shaft on the vehicle.

6. The clutch of claim 5, wherein said clutch bearing is a drawn-cup, needle clutch bearing.

7. The clutch of claim 5, wherein the shaft is hollow and has an inner surface, and wherein the means for rotatably mounting said shaft on the vehicle comprises a second shaft having an outer surface with a diameter less than the diameter of the inner surface of the hollow shaft and wherein the second shaft is fixedly mounted to the vehicle and wherein the hollow shaft is rotatably supported concentrically around the second shaft by needle bearings installed between and in contact with the outer surface of the second shaft and the inner surface of the hollow shaft.

8. The clutch of claim 7, wherein the second shaft has two ends and the second shaft is fixedly mounted to the vehicle by supports between each end to the case of said engine.

9. An engine-assisted vehicle comprising:
A vehicle having at least one wheel;
An engine mounted on said vehicle;
A centrifugal clutch comprising a shoe drive assembly having a hub with an inner surface, and a drum assembly having a hub with an inner surface;
A rotatable input drive member fixedly mounted to the shoe drive assembly;
A rotatable output driven member fixedly mounted to the drum assembly;
A unidirectional clutch bearing having an inner surface and an outer surface, the outer surface of the bearing fixedly mounted to the inner surface of the hub of at least one of the shoe drive assembly and the drum assembly;
A shaft fixedly mounted to the inner surface of the hub of the drum assembly, and fitted against the inner surface of said clutch bearing to allow rotation of the shaft in one direction only; and
A means for rotatably mounting said shaft on the vehicle.

10. A method for retrofitting the clutch on an engine-assisted vehicle, comprising the steps of:
providing a centrifugal clutch comprising a shoe drive assembly having a hub with an inner surface, and a drum assembly having a hub with an inner surface;
providing a rotatable input drive member fixedly mounted to the shoe drive assembly;
providing a rotatable output driven member fixedly mounted to the drum assembly;
providing a unidirectional clutch bearing having an inner surface and an outer surface, the outer surface of the bearing fixedly mounted to the inner surface of the hub of at least one of the shoe drive assembly and the drum assembly;
providing a shaft fixedly mounted to the inner surface of the hub of the drum assembly, and fitted against the inner surface of said clutch bearing to allow rotation of the shaft in one direction only; and
providing a means for rotatably mounting said shaft on the vehicle.

11. The method of claim 10 wherein the vehicle has original production model components including an engine with a case, a clutch, belt and pulley components, four stanchions connected to the case of the engine, and a cover, further comprising the steps of:
removing the original production model clutch and belt and pulley components from the vehicle;
providing a left support arm and mounting it to the four stanchions connected to the case of the engine;
rotating the original production model cover down and mounting it to the left support arm; and
rotatably mounting a right support arm to the engine.
